(19) United States
(12) Patent Application Publication
(10) Pub. No.: US 2012/0121472 A1
(43) Pub. Date: May 17, 2012

(54) FLUE GAS CLEANING STAGE

(76) Inventor: Franz-Josef Zurhove, Waldshut-Tiengen (DE)

(21) Appl. No.: 13/278,359

(22) Filed: Oct. 21, 2011

(30) Foreign Application Priority Data
Oct. 21, 2010 (DE) 10 2010 060 104.7

(51) Int. Cl. B01D 53/34

(52) U.S. Cl. 422/168

(57) ABSTRACT

The flue gas cleaning stage according to the invention for cleaning dust-laden exhaust gases has an SCR catalytic convertor for NO_{X} reduction which has at least three catalytic converter layers which are arranged one behind the other in the flow direction of the exhaust gases, the first catalytic convertor layer in the flow direction having a shorter length than the following layers.

### TECHNICAL FIELD

The invention relates to a flue gas cleaning stage for cleaning dust-laden exhaust gases with a selective catalytic reduction (SCR) catalytic convertor, which has at least three catalytic convertor layers which are arranged one behind the other in the flow direction of the exhaust gases and a cement production plant having such a flue gas cleaning stage.

### BACKGROUND OF THE INVENTION

In the catalytic reduction of nitrogen oxides (NO_{X}) and volatile organic compounds (VOC), reaction temperatures of at least 260° C. are necessary with high loads of sulphur in the exhaust gas, as occur, for example, in cement production plants. The catalytic convertors which are conventionally used contain as an active element vanadium pentoxide, a higher content of vanadium being required as the temperature decreases in order to achieve the same pollutant conversion. In cement production plants, owing to the loads of sulphur, it is generally necessary to place the catalytic convertor directly downstream of the cyclone preheater since more favourable temperatures of approximately from 280 to 400° C. are present at that location for process-related reasons. Similar conditions arise, for example, with plants for calcining and roasting metal ores, which are also provided with cyclone heat exchangers.

In a disadvantageous manner, however, after the last preheating cyclone there are high dust loads in the order of magnitude of from 30 to over 180 g/Nm³. These high loads of dust lead to operational problems in the form of clogging of the catalytic convertor and reduction of the activity of the porous catalytic convertor surface owing to coatings of dust.

The sizing of the catalytic convertor surface required is substantially dependent on the amount of gas to be cleaned and the degree of pollutant decomposition desired. In order to keep the volume of the catalytic convertor small, a high volume-related catalytic convertor surface of, for example, 300 m²/m³, is desired. The cross-section is determined by the predetermined gas speed in the catalytic convertor channels and the quantity of gas so that a required total length is consequently produced. This can generally not be implemented in one layer since the length is limited for technical reasons relating to both the process and production. Owing to continual improvements in the production process, values of up to 1.3 are now achieved with honeycomb-type catalytic convertors. With regard to technical aspects of the plant, it is desirable to achieve the total length with the smallest possible number of layers since the costs for the housing, maintenance devices and cleaning are thereby reduced. Conventionally, therefore, a plurality of catalytic convertor layers with a length of more than 1 m are introduced into the catalytic convertor housing.

The use of a catalytic convertor with flue gases with high dust contents, as occur, for example, in cement production, has already been described in a large number of publications. For instance, the use of compressed air blowers to clean occurrences of clogging is set out in DE 100 11 327 A1. In DE 10 2005 039 997 A1 in order to support the cleaning power of the dust blowers, an acoustic cleaning operation using sonic horns is further proposed. DE 100 11 327 A1 sets out the dependency of the occurrences of clogging and operational malfunctions on the Froude number. WO 97/09112 A1 describes a method with an upstream template for protecting the catalytic convertor. CH 698 991 B1 relates to the combination of SCR and SNCR, whilst EP 1 735 576 B1 discloses the decomposition of NO_{X} with CO.

However, all the published methods have not yet been able to reduce operational malfunctions in a satisfactory manner owing to high dust loads and/or very cohesive dust. WO 2010015009 and WO 2010073090 therefore proposed SCR catalytic convertors with a preliminary dust removal operation in order to reduce the dust content.

However, since hot dust removal involves considerable additional expenditure, an object of the present invention is to develop a flue gas cleaning stage which allows disruption-free operation of catalytic convertors, even with high loads of dust.

### SUMMARY OF THE INVENTION

According to the invention, this object is achieved by the features of claim 1.

The flue gas cleaning stage according to the invention for cleaning dust-laden exhaust gases has an SCR catalytic convertor for NO_{X} reduction, which has at least three catalytic convertor layers which are arranged one behind the other in the flow direction of the exhaust gases, the first catalytic convertor layer in the flow direction having a shorter length than the following layers.

In the tests forming the basis of the invention and in industrial operation, it has been found that dust deposits in the channels of the individual catalytic convertor layers are accompanied by high pressure losses. The deposits lead to increased resistance to throughflow, which reduces the speed which can be achieved, in particular when cleaning compressed air. The cleaning power thereby decreases and there is consequently a bridge growth in the channels of the catalytic convertor until finally the channels are completely closed by dust. From a specific size, these dust bridges can no longer be cleaned away by means of compressed air.

Furthermore, it has been observed that the catalytic convertor layers in the reactor housing bring about owing to their geometry a rectification of the flow and a standardisation of the load of dust. The flow resistance of a layer produces a pressure difference which is dependent on the gas speed and consequently also a homogenisation of the speed values over the cross-section. This effect of rectification and homogenisation is, however, only apparent in the incoming flow of the second catalytic convertor layers. A non-uniform incoming flow, as occurs in the first catalytic convertor layer, leads, owing to high local dust concentrations and local speed gradients, to an increasing risk of bridge formation in the catalytic convertor channels. These bridge formations of the first layers thereby increase much more quickly than in the following layers.

There are already various attempts and constructions to achieve a homogeneous distribution even upstream of the first catalytic convertor layer. These include inter alia baffle plates and a dummy layer. In practice, however, these have not led to the uppermost catalytic convertor layer operating with comparable pressure losses in the same manner as the following ones. This is attributed in particular to the fact that the dummy layers have substantially smaller levels of resistance and therefore do not have an equivalent effect. Furthermore, they involve additional cost in terms of production and cleaning, without having a pollutant-reducing effect. Owing to the measure according to the invention that the first catalytic convertor layer in the flow direction has a shorter length than the following layers, the operation of the flue gas cleaning stage was able to be significantly optimised.

The dependent claims relate to other configurations of the invention.

According to a preferred configuration of the invention, the relationship of the shortest to the longest catalytic convertor layer is less than 0.7, preferably less than 0.5. It has further been found to be advantageous for the first catalytic convertor layer to have a length which corresponds to the length of the influx turbulence which is produced owing to the exhaust gases passing through +/−25%.

According to another configuration of the invention, the first catalytic convertor layer has a larger pitch than the following layers. Typically, catalytic convertor elements with between 10×10 and 18×18 channels on 150 mm×150 mm are used in the cement industry. Owing to the use, for example, of 8×8 elements in the first layer, the risk of clogging in this region can be further reduced. As the number of layers which are passed through increases, the flow becomes standardised so that in the third layer it is possible to use, for example, 13×13 elements.

In the tests forming the basis of the invention, it was further found to be advantageous for the first catalytic convertor layer to be constructed as a plate-type catalytic convertor and for the following layers to be constructed as a honeycomb-type catalytic convertor.

The specific surface-area of the catalytic convertor also has, in addition to the reduction potential for NO_{X}, oxidative properties for some pollutants. For instance, hydrocarbons of different chain lengths are oxidised with oxygen. Both the NO_{X} reduction and the VOC oxidation increase with the vanadium pentoxide content of the catalytic convertor. In addition to the vanadium pentoxide content, the substance transport of the pollutants to the active centres of the catalytic convertor has a decisive influence on the conversion.

In the catalytic convertor channels at typical gas speeds of 5 m/s there is a laminar flow path. Only in the inlet region of the catalytic convertor are there occurrences of swirling and consequently turbulent relationships. According to Binder-Bergsteiger et al., “Zur Kinetik der Denox-Reaktion an TiO₂/WO₃-Wabenkatalysatoren” (Kinetics of the Denox reaction on TiO₂/WO₃ honeycomb-type catalytic convertors), Chemical Engineering Technology Vol. 62, P. 60-61, January 1990, the following formula applies:

Length of the influx turbulence=0.03*Reynolds number*hydraulic diameter

However, it has been found that turbulent relationships, such as those in the influx region of the catalytic convertor lead to improved substance transport.

In FIG. 3, the length of the influx turbulence is indicated dependent on the speed and number of cells. Influx turbulences in a length of between 100 and 1400 mm are produced, turbulent stretches greater than 500 mm appearing only at high flow speeds and consequently high pressure losses and at the same time with a small number of cells, at which a very much higher volume of catalytic convertor is required owing to the smaller specific surface-area.

Under typical operating conditions of 5 m/s and with a cell number of 10×10, the inlet turbulence is present approximately in the first 400 mm. Catalytic convertor lengths of 1200 mm therefore have a lesser pollutant conversion than a division of the same volume into three elements, each of 400 mm. For a high level of pollutant decomposition, it is therefore recommended to divide the catalytic convertor volume in this instance with elements of a length of 400 mm and to provide a greater number of layers. However, since each catalytic convertor layer has its own cleaning device in the form of a dust blower, the complexity of the plant is thereby increased. However, so that the plant complexity does not increase disproportionately, there is provision according to the invention for the first catalytic convertor layer to have a shorter length than the following layers. Owing to the shortened first catalytic convertor layer a more homogeneous dust and flow distribution is produced, which causes fewer dust deposit peaks and consequently lower pressure losses in the subsequent layers. Furthermore, the VOC conversion in the first catalytic convertor layer can be increased by the occurrences of influx turbulence.

For the NO_{X} reduction, a supply device for ammonia or an ammonia-containing reduction agent is required. The supply is advantageously already carried out upstream of the catalytic convertor. In an optional configuration of the invention, it is possible to carry out the supply only downstream of the first layer so that, in the first catalytic convertor layer, the VOC oxidation substantially takes place and not the reduction of NO_{X} at the same time.

In other branches of industry, such as the solvent sector, so-called oxidation catalytic convertors are also used for VOC reduction and are provided, for example, with precious metals for improved oxidation. However, it has been found in practice that the specific composition of the exhaust gas and the dust load, as produced in particular in cement production, can lead to a rapid deactivation of these catalytic convertors. However, it is completely conceivable that a further development of the technology of the oxidation catalytic convertors will also allow future use in the shortened first layer.

### BRIEF DESCRIPTION OF THE DRAWINGS

Other configurations and advantages of the invention will be explained below with reference to the following description and the drawings, in which:

FIG. 1 is a schematic block diagram of a cement production plant,

FIG. 2 is a detailed schematic illustration of FIG. 1 in the region of the preheater and the exhaust gas cleaning step,

FIG. 3 is a graph of the connection between the length of the influx turbulence and the gas speed and the cell number of a catalytic convertor unit,

FIG. 4 is a plan view of a catalytic convertor unit of the first catalytic convertor layer according to a first embodiment,

FIG. 5 is a plan view of a catalytic convertor unit of the first catalytic convertor layer according to a second embodiment,

FIG. 6 is a plan view of a catalytic convertor unit of a catalytic convertor layer which is arranged downstream.

### BRIEF DESCRIPTION OF ILLUSTRATIVE EMBODIMENTS

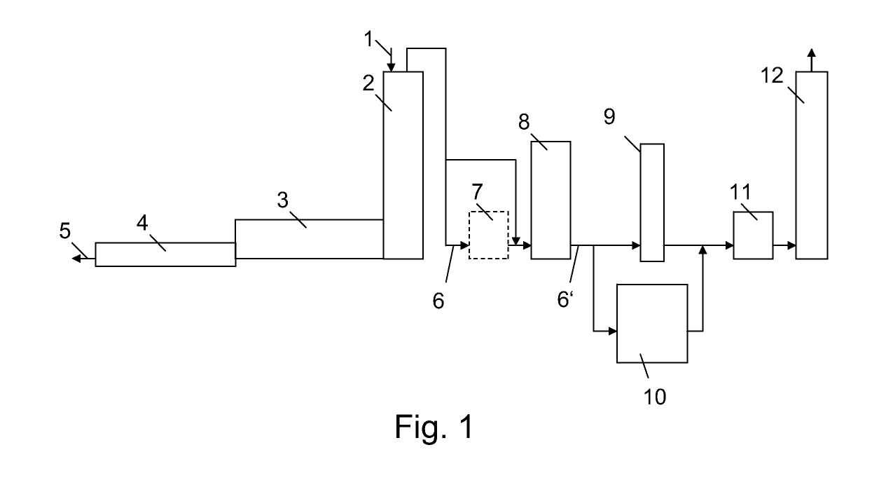

In the cement production plant illustrated in FIG. 1, raw meal 1 is supplied to a preheater 2 in order to preheat the raw meal. The preheated raw meal then arrives at an oven 3 to be baked. The baked material is subsequently cooled in a cooler 4 and removed as cement clinker 5.

The exhaust gases produced in the oven 3 and a calcinator optionally arranged between the preheater and oven are used to preheat the raw meal 1 in the preheater 2. The dust-laden exhaust gas leaves the preheater 2 with a temperature of approximately from 280 to 400° C. and is supplied directly or via a preliminary dust removal device 7 to a flue gas cleaning stage 8.

The preliminary dust removal device 7 is constructed, for example, as a hot gas dust removal device and is intended to reduce the dust content of the exhaust gas 6, for example, to from 1 to 20 g/Nm³. Depending on the dust content of the exhaust gas 6 of the preheater 2, however, it is also possible in some circumstances to dispense with the preliminary dust removal device 7.

The exhaust gas 6′ discharged from the flue gas cleaning stage 8 is optionally cooled in a cooling tower 9 or used in a grinding drying device 10 before dust is removed therefrom in the dust filter 11 and the gas reaches the atmosphere via a chimney 12.

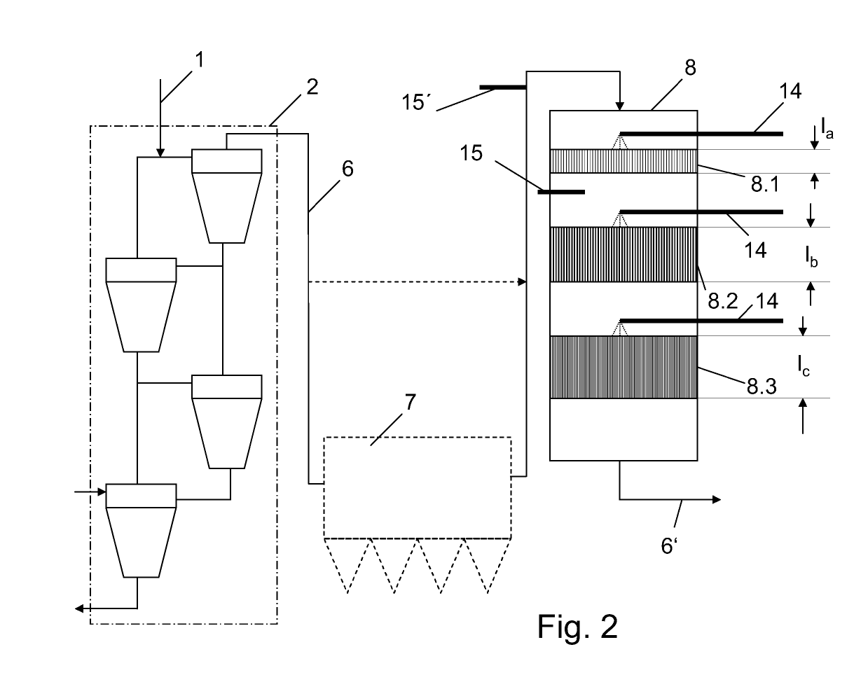

In FIG. 2, the preheater 2, the preliminary dust removal device 7 and the flue gas cleaning stage 8 are illustrated in greater detail.

The preheater 2 is generally constructed as a multi-stage cyclone preheater, the oven exhaust gases being directed through the preheater in counter-current to the raw meal 1 to be preheated.

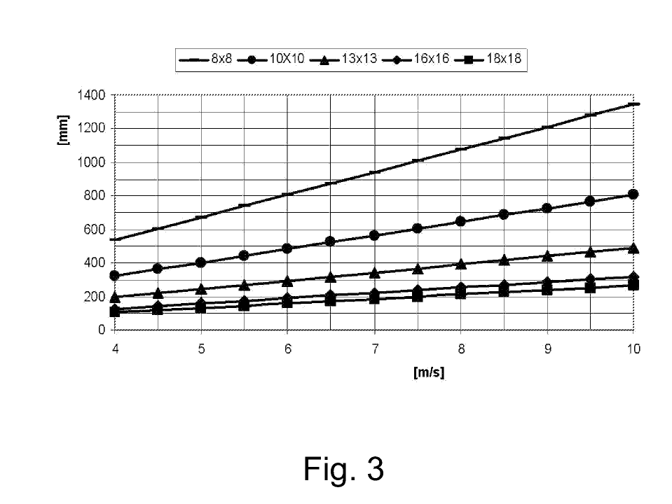

The flue gas cleaning stage 8 provides an SCR catalytic convertor which in the embodiment illustrated has three catalytic convertor layers 8.1, 8.2, 8.3 which are arranged one behind the other in the flow direction of the exhaust gases, the first catalytic convertor layer 8.1 in the flow direction having a smaller length lₐ than the lengths l_{b}, l_{c} of the following layers 8.2, 8.3. In the embodiment illustrated, the length l_{c} of the third catalytic convertor layer 8.3 is longer than the length l_{b} of the second catalytic convertor layer 8.2. In the context of the invention, however, it is completely conceivable for only the first layer to be shortened, whilst the subsequent catalytic convertor layers have the same lengths. According to a preferred configuration, the relationship lₐ/l_{c} of the shortest to the longest catalytic convertor layer is less than 0.7, preferably less than 0.5. It has further been found to be advantageous for the length lₐ of the first catalytic convertor layer 8.1 to correspond to the length of the influx turbulence produced as a result of the passing exhaust gas 6 +/−25%. For the calculation of this length, reference can be made to the formula set out above and FIG. 3.

With such a sizing, VOC oxidation which is preferably produced in the region of the influx turbulence substantially occurs in the first catalytic convertor layer.

For NO_{X} reduction, a supply device 15, 15′ for ammonia or an ammonia-containing reduction agent is required. The supply can already be carried out upstream of the catalytic convertor (supply device 15′). In an optional configuration of the invention, it is possible to carry out the supply only after the first catalytic convertor layer 8.1 via a supply device 15, so that in the first catalytic convertor layer substantially the VOC oxidation takes place and not the reduction of NO_{X} at the same time.

Each catalytic convertor layer can further also be provided with dust blowers 14 or other suitable cleaning devices for removing dust deposits on the SCR catalytic convertor.

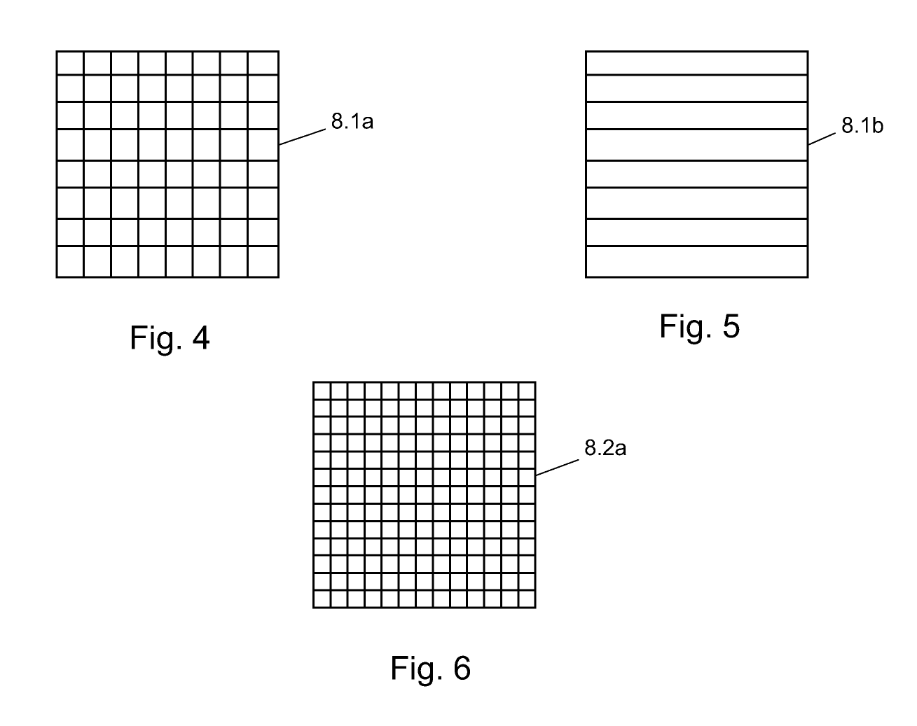

FIG. 4 is a plan view of a catalytic convertor element 8.1a which has, for example, a dimension of 150 mm*150 mm. The entire catalytic convertor layer 8.1 comprises, for example, 72 such catalytic convertor elements 8.1a which are combined in so-called module cases. The catalytic convertor element illustrated in FIG. 4 is a honeycomb-type catalytic convertor which has a channel number of 8*8.

As an alternative, a plate-type catalytic convertor may in particular also be considered for the first catalytic convertor layer 8.1. A corresponding plate-type catalytic convertor element 8.1b is illustrated in FIG. 5. For the subsequent catalytic convertor layers 8.2 and 8.3, honeycomb-type catalytic convertors can preferably be considered since these have a greater active surface-area per volume. Since the exhaust gas flow in the subsequent layers is already more homogeneous and the tendency towards dust deposits is therefore also correspondingly reduced at that location, the pitch can be reduced and the number of channels can be increased accordingly. A catalytic convertor element 8.2a with 13×13 channels is illustrated by way of example in FIG. 6.

In the tests forming the basis of the invention, it was found that the shortened first catalytic convertor layer 8.1 alone could significantly reduce the tendency towards occurrences of clogging by dust being deposited. This effect is increased by the additional measure that a greater pitch, that is to say, channels which have a larger cross-section than in the subsequent layers, is used in the first catalytic convertor layer.

1. Flue gas cleaning stage for cleaning dust-laden exhaust gases with an SCR catalytic convertor for NO_{X} reduction, which has at least three catalytic convertor layers, which are arranged one behind the other in the flow direction of the exhaust gases, characterised in that the first catalytic convertor layer in the flow direction has a shorter length than the following layers.

2. Flue gas cleaning stage according to claim 1, characterised by a supply device for ammonia or an ammonia-containing reduction agent.

3. Flue gas cleaning stage according to claim 1, characterised in that the relationship (lₐ/l_{c}) of the shortest to the longest catalytic convertor layer is less than 0.7.

4. Flue gas cleaning stage according to claim 1, characterised in that the relationship (lₐ/l_{c}) of the shortest to the longest catalytic convertor layer is less than 0.5.

5. Flue gas cleaning stage according to claim 1, characterised in that particularly the first catalytic convertor layer has a length (lₐ) which corresponds to the length of the influx turbulence which is produced owing to the exhaust gases passing through plus/minus 25%.

6. Flue gas cleaning stage according to claim 1, characterised in that at least the first catalytic convertor layer has a larger pitch than the following layers.

7. Flue gas cleaning stage according to claim 1, characterised in that the shortened first catalytic convertor layer is formed as a plate-type catalytic convertor and the following layers are formed as a honeycomb-type catalytic convertor.

8. Flue gas cleaning stage according to claim 1, characterised in that a supply device for ammonia or an ammonia-containing reduction means is arranged in the flow direction only downstream of the first catalytic converter layer.

9. Flue gas cleaning stage according to claim 1, characterised in that at least the first catalytic convertor layer is formed by an oxidation catalytic converter.

10. Cement production plant having a preheater for preheating raw material, an oven for baking the raw material and a cooler for cooling the baked raw material, the exhaust gases of the oven being used in the preheater and a flue gas cleaning stage adjoining in the flow direction of the exhaust gases downstream of the preheater according to one or more of the preceding claims.
